(19) United States
(12) Patent Application Publication
(10) Pub. No.: US 2022/0086782 A1
(43) Pub. Date: Mar. 17, 2022

(54) SIDELINK SYNCHRONIZATION SIGNAL BLOCK (S-SSB) DESIGN

(71) Applicant: MediaTek Singapore Pte. Ltd., Singapore (SG)

(72) Inventors: Tao CHEN, Beijing (CN); Zhixun TANG, Beijing (CN); Min LEI, Beijing (CN)

(73) Assignee: MediaTek Singapore Pte. Ltd., Singapore (SG)

(21) Appl. No.: 17/419,993

(22) PCT Filed: Jan. 10, 2020
(86) PCT No.: PCT/CN2020/071380

§ 371 Date: Jun. 30, 2021

(30) Foreign Application Priority Data
Jan. 10, 2019 (CN) PCT/CN2019/071224
Feb. 18, 2019 (CN) PCT/CN2019/075360

(51) Int. Cl. H04W 56/00; H04L 5/00

(52) U.S. Cl. CPC H04W 56/0015; H04L 5/001; H04L 5/0051

(57) ABSTRACT

A method of synchronization for sidelink communications can include synchronize to a synchronization source at a user equipment (UE) to determine a frame timing for sidelink communications, and transmitting a sidelink synchronization signal block (S-SSB) according to the frame timing. When the synchronization source is a global navigation satellite system (GNSS), a slot number can be determined according to a GNSS timing and a subcarrier spacing. In one embodiment, the slot number can be determined based on a function of μ,Tcurrent, Tref and offsetDFN.

### CROSS REFERENCE TO RELATED PATENT APPLICATION(S)

This present application claims the benefit of International Application No. PCT/CN2019/071224, “NR V2X Sidelink Synchronization Signal Block” filed on Jan. 10, 2019, and No. PCT/CN2019/075360, “SSB Design for V2X Communication” filed on Feb. 18, 2019, which are incorporated herein by reference in their entirety.

### TECHNICAL FIELD

The present disclosure relates to wireless communications, and specifically relates to sidelink communications for vehicular applications and enhancements to cellular infrastructure.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Cellular based vehicle-to-everything (V2X) (e.g., LTE V2X or NR V2X) is a radio access technology developed by the Third Generation Partner Project (3GPP) to support advanced vehicular applications. In V2X, a direct radio link (referred to as a sidelink) can be established between two vehicles. The sidelink can operate under the control of a cellular system (e.g., radio resource allocation) when the vehicles are within the coverage of the cellular system. Or, the sidelink can operate independently when no cellular system is present.

### SUMMARY

Aspects of the disclosure provide a method of synchronization for sidelink communications. The method can include synchronize to a synchronization source at a user equipment (UE) to determine a frame timing for sidelink communications, and transmitting a sidelink synchronization signal block (S-SSB) according to the frame timing. When the synchronization source is a global navigation satellite system (GNSS), the determining the frame timing can include determining a slot number according to a GNSS timing and a subcarrier spacing. In one embodiment, the slot number can be determined based on a function of μ,Tcurrent, Tref and offsetDFN. In a specific example, the function could be:

slot number=Floor (0.001*(Tcurrent−Tref−offsetDFN)*2\hat{ }μ)mod 2\hat{ }μ,

where μ is an integer indicating a numerology corresponding to a subcarrier spacing, Tcurrent denotes a current time obtained from the GNSS in μs, Tref denotes a reference time in μs, and offsetDFN denotes a timing difference between a wireless network and the GNSS.

In an embodiment, the S-SSB includes a physical sidelink broadcast channel (PSBCH) that carries information of a slot number. In an embodiment, the S-SSB includes a PSBCH demodulation reference signal (DMRS) sequence that is generated with a time domain S-SSB transmission resource indicator as an initialization value.

In an embodiment, the S-SSB has a PSBCH DMRS resource element (RE) mapping of a fixed RE location with respect to different sidelink synchronization signal (SLSS) identifier (ID). In an embodiment, the S-SSB includes sidelink primary synchronization signal (S-PSS) symbols of a S-PSS, sidelink secondary synchronization signal (S-SSS) symbols of a S-SSS, and PSBCH symbols of a PSBCH. Each of the S-PSS symbols, the S-SSS symbols, and the PSBCH symbols has a same total transmission power. A transmission power per RE of a PSBCH DMRS in the S-SSB is the same as that of the S-PSS, the S-SSS, or the PSBCH in the S-SSB.

In an embodiment, the method can further include transmitting a sequence of S-SSBs that are evenly distributed in time domain in a S-SSB burst set. In one example, the sequence of S-SSBs are each positioned at the beginning of a 0.5 ms half-subframe. In an embodiment, the S-SSB includes PSBCH symbols that are repeated PSBCH by PSBCH or symbol by symbol.

Aspects of the disclosure provide an apparatus comprising circuitry. The circuitry can be configured to synchronize to a synchronization source at a UE to determine a frame timing for sidelink communications, and transmit a S-SSB according to the frame timing. The circuitry is configured to, when the synchronization source is a GNSS, determine a slot number according to a GNSS timing and a subcarrier spacing. In one embodiment, the slot number can be determined based on a function of μ,Tcurrent, Tref and offsetDFN. In a specific example, the function could be:

slot number=Floor (0.001*(Tcurrent−Tref−offsetDFN)*2\hat{ }μ)mod 2\hat{ }μ,

where μ is an integer indicating a numerology corresponding to a subcarrier spacing, Tcurrent denotes a current time obtained from the GNSS in μs, Tref denotes a reference time in μs, and offsetDFN denotes a timing difference between a wireless network and the GNSS.

Aspects of the disclosure provide a non-transitory computer-readable medium storing instructions that, when executed by a processor, cause the processor to perform the method of synchronization for sidelink communications.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a wireless communication system 100 according to an embodiment of the disclosure;

FIG. 2 shows a cluster 200 of user equipments (UEs) 201-205 according to an embodiment of the disclosure;

FIG. 3 shows another cluster 300 of UEs 301-304 according to an embodiment of the disclosure;

FIG. 4 shows an example sidelink synchronization signal block (S-SSB) 400 according to an embodiment of the disclosure;

FIG. 5 shows an example of S-SSB transmission according to an embodiment of the disclosure;

FIG. 6 shows a S-SSB 640 transmitted from a transmitting UE over a slot 630 contained in a subframe 620 of a frame 610;

FIGS. 7A and 7B show two physical sidelink broadcast channel demodulation reference signal (PSBCH DMRS) mapping patterns 700A and 700B, respectively, according to some embodiments of the disclosure;

FIG. 8 shows three subframes 831-833 with subcarrier spacings of 15 kHz, 30 kHz, and 60 kHz, respectively. Each subframe 831-833 lasts for 1 ms;

FIG. 9 shows three example S-SSBs 910-930 according to some embodiments of the disclosure;

FIG. 10 shows an example S-SSB 1000 according to an embodiment;

FIG. 11 shows another example S-SSB 1100 with PSBCH repetition;

FIG. 12 shows an example S-SSB 1200 with additional symbol(s) for automatic gain control (AGC) tuning;

FIG. 13 shows an example of mapping a AGC tuning symbol associated with a S-SSB 1310 to a first symbol of a slot 1320 with a longer cyclic prefix (CP);

FIG. 14 shows an example of S-SSBs with GP symbols for beam-switching;

FIG. 15 shows a PSBCH DMRS pattern with a 60 kHz subcarrier spacing;

FIG. 16 shows another PSBCH DMRS pattern with a 60 kHz subcarrier spacing;

FIG. 17 shows a synchronization process 1700 of sidelink communications according to an embodiment of the disclosure;

FIG. 18 shows an exemplary apparatus 1800 according to embodiments of the disclosure.

### DETAILED DESCRIPTION OF PREFERRED IMPLEMENTATIONS

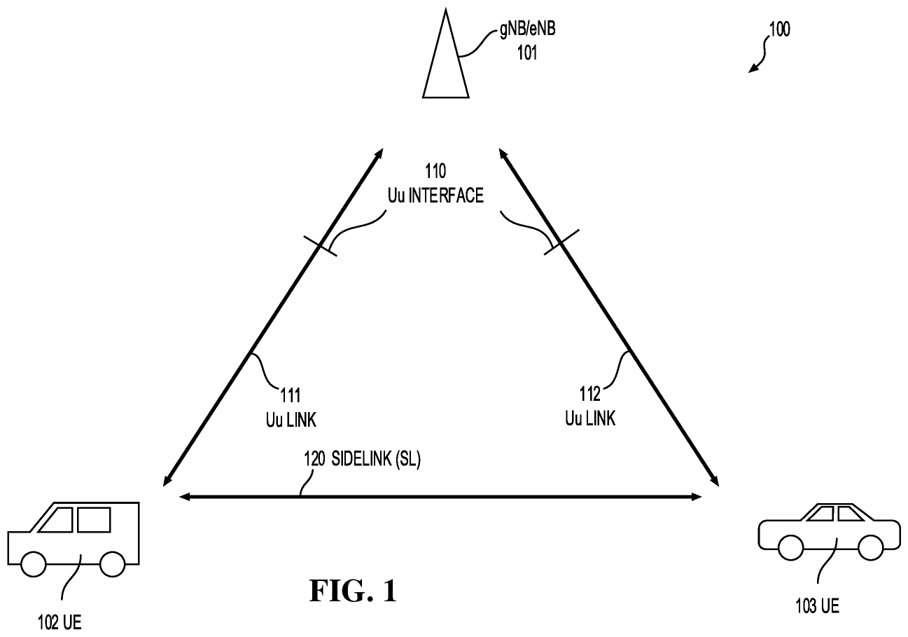

FIG. 1 shows a wireless communication system 100 according to an embodiment of the disclosure. The system 100 can include a base station (BS) 101, a first user equipment (UE) 102, and a second UE 103. The BS 101 can be an implementation of a gNB specified in the 3rd Generation Partnership Project (3GPP) New Radio (NR) standards, or can be an implementation of an eNB specified in 3GPP Long Term Evolution (LTE) standards. Accordingly, the BS 101 can communicate with the UE 102 or 103 via a radio air interface 110 (referred to as a Uu interface 110) according to respective wireless communication protocols. Alternatively, the BS 101 may implement other types of standardized or non-standardized radio access technologies, and communicate with the UE 102 or 103 according to the respective radio access technologies. The UE 102 or 103 can be a vehicle, a computer, a mobile phone, a roadside unit, and the like.

The UE 102 and UE 103 can communicate with each other based on vehicle-to-everything (V2X) technologies specified in 3GPP standards. A direct radio link 120, referred to as a sidelink (SL), can be established between the UEs 102 and 103. The UE 102 can use a same spectrum for uplink transmissions over a Uu link 111 and SL transmissions over the SL 120. Similarly, the UE 103 can use a same spectrum for uplink transmissions over a Uu link 112 and SL transmissions over the SL 120. In addition, allocation of radio resources over the SL 120 can be controlled by the BS 101.

Different from the FIG. 1 example (in-coverage scenario) where the UEs 102 and 103 performing sidelink communications are under network coverage (the coverage of a cell of the BS 101), in other examples, UEs taking part in sidelink communications can be outside network coverage. For example, a sidelink can be established between two UEs both of which are located outside of network coverage (out-of-coverage scenario), or one of which is located outside of network coverage (partial-coverage scenario).

In various embodiments, in order to establish sidelink connectivity, the UEs in the above examples can first perform synchronization to each other or to respective overlaid network if present. For example, there can be four basic synchronization sources (or synchronization references) from which a UE can derive its own synchronization: a global navigation satellite system (GNSS), a gNB/eNB, another UE transmitting sidelink synchronization signal blocks (S-SSBs) (referred to as a SyncRef UE), or an internal clock of the UE. In some examples, a GNSS or a eNB/gNB synchronization source is regarded as the highest-quality synchronization sources. The SyncRef UEs can further be categorized into three subgroups: first UEs that are directly synchronized to the GNSS or the gNB/eNB, second UEs that are 1 further step away from the GNSS or the gNB/eNB, and third UEs that are 2 or more steps away from the GNSS or the gNB/eNB. When a UE is unable to find any other synchronization reference, the UE can use its internal clock to transmit S-SSBs.

In an example, the different synchronization sources of the above basic synchronization sources are categorized into different priority levels from Level 1 to Level 7 with decreasing priorities:

Level 1. Either GNSS or eNB/gNB, according to (pre-)configuration.

Level 2. A SyncRef UE directly synchronized to a Level 1 source.

Level 3. A SyncRef UE synchronized to a Level 2 source, i.e. indirectly synchronized to a Level 1 source.

Level 4. Whichever of GNSS or eNB/gNB was not (pre-)configured as the Level 1 source.

Level 5. A SyncRef UE directly synchronized to a Level 4 source.

Level 6. A SyncRef UE synchronized to a Level 5 source, i.e. indirectly synchronized to a Level 4 source.

Level 7. Any other SyncRef UE.

Level 8. UE's internal clock.

The above synchronization source priority rule can be configured to a UE (e.g., by system information block (SIB) or dedicated radio resource management (RRC) signaling), or preconfigured to a UE (e.g., by storage to the UE or to a subscriber identification module (SIM) at the UE). During a synchronization procedure, the UE can accordingly select a synchronization source with the highest priority to derive a transmission timing or reception timing.

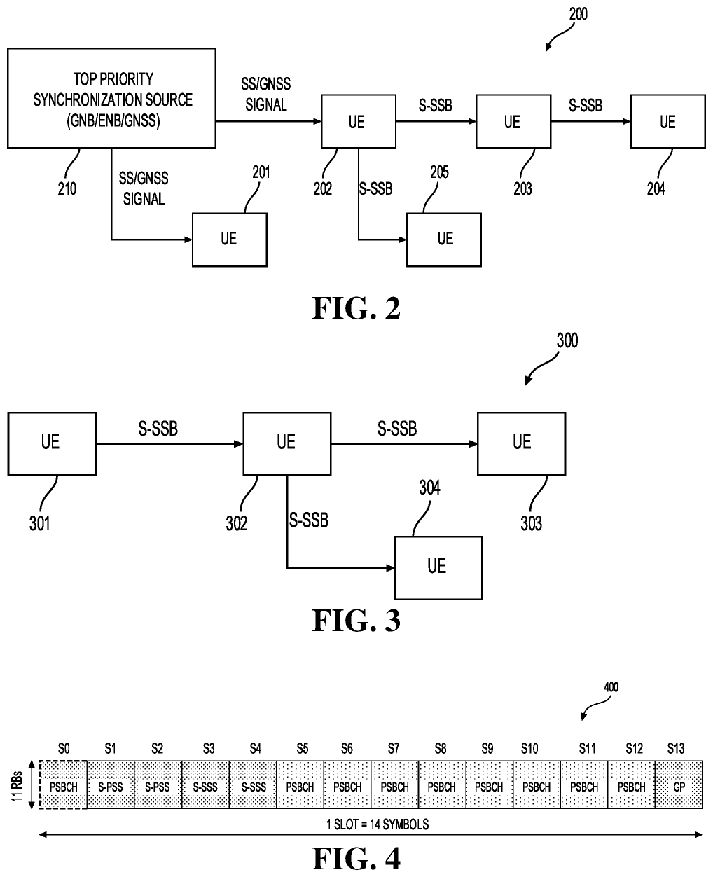

FIG. 2 shows a cluster 200 of UEs 201-205 according to an embodiment of the disclosure. Each UE 201-205 synchronizes to a nearby synchronization source and accordingly determines a transmission timing or a reception timing for sidelink communications (e.g., unicast, groupcast, or broadcast) with nearby UEs within the cluster 200. A synchronization source 210 (e.g., a gNB, an eNB, or a GNSS) (or a synchronization signal (SS) from the synchronization source 210) is used as a top priority timing reference which is extended to the UEs 201-205 within the cluster 200.

For example, the UEs 201-202 are within the coverage of the synchronization source 210, and accordingly can directly synchronize to the synchronization source 210. For example, a gNB or eNB may periodically transmit LTE or NR synchronization signals (SSs) such as primary synchronization signal (PSS), secondary synchronization signal (SSS), and physical broadcast channel (PBCH) signal. GNSS satellites may continuously transmit navigation signals. Using those signals as timing references, the UEs 201-202 can obtain the reference timing, and accordingly determine the transmission or reception timing of itself.

After being synchronized to the synchronization source 210, the UE 202 can transmit synchronization signals in line with the transmission timing synchronized to the synchronization source 210. The synchronization signals can be a sequence of periodically transmitted S-SSB bursts. Each S-SSB burst includes one or more S-SSBs and is transmitted in a S-SSB transmission period. The S-SSBs can each include a sidelink primary synchronization signal (S-PSS), a sidelink secondary synchronization signal (S-SSS), and a sidelink physical broadcast channel (S-PBCH, or PSBCH) signal.

In an example, whether the UE 202 should transmit the S-SSBs or not can be controlled by control information received from a gNB or an eNB which the UE 202 is connected to or camped on. In an example, when the control information is not present, the UE 202 itself can make a decision when to transmit the S-SSB. For example, the UE 202 can determine to transmit the S-SSB when a quality (e.g., indicated by reference signal received power (RSRP)) of a signal from the gNB or the eNB is below a threshold.

By receiving the S-SSB from the UE 202 as a timing reference, the UEs 203 and 205, which are out of the coverage of the top priority timing reference 210, can synchronize to the UE 202, and becomes indirectly synchronized to the top priority synchronization source 210.

Similarly, the UE 203 can transmit a S-SSB that is synchronized to the timing reference of the UE 202. By using the S-SSB of the UE 203 as a timing reference, the UE 204 can by synchronized to the UE 203.

FIG. 3 shows another cluster 300 of UEs 301-304 according to an embodiment of the disclosure. Each UE 301-304 synchronizes to a nearby synchronization source in order to determine a transmission timing or a reception timing for sidelink communications (e.g., unicast, groupcast, or broadcast) with nearby UEs within the cluster 300. In the cluster 300, none of the UEs 301-304 is within the coverage of a gNB, eNB, or GNSS synchronization source (e.g., the synchronization source 210 in the FIG. 2 example).

For example, when the UE 301 is powered on or has lost synchronization to other synchronization sources (e.g., a gNB, an eNB, a GNSS, or a UE), the UE 301 tries to search for a synchronization source (e.g., a gNB, an eNB, a GNSS, or a UE) and is not successful. Accordingly, the UE 301 may autonomously determine a transmission timing, and transmit a S-SSB based on this transmission timing. The UE 302 can use the S-SSB from the UE 301 as a timing reference and determine a transmission timing of the UE 302. In a similar way, the UEs 303-304 can perform synchronization based on a S-SSB transmitted from the UE 302.

FIG. 4 shows an example S-SSB 400 according to an embodiment of the disclosure. The S-SSB 400 can occupy 14 symbols of a slot 401 indexed from S0-S13 in time domain, and 11 resource blocks (RBs) (or referred to as physical resource blocks (PRBs)) in frequency domain (e.g., each RB includes 12 subcarriers). The S-SSB 400 includes a S-PSS repeated over symbols S1 and S2, a S-SSS repeated over symbols S3 and S4, and a PSBCH (together with PSBCH demodulation reference signals (DMRSs) occupying symbols S0 and S5-S12. A guard period (GP) symbol is appended at symbol S13.

The S-PSS and S-SSS in the S-SSB 400 can be an M-sequence and a Gold sequence, respectively, in some examples. Repetition of the S-PSS or S-SSS allows detectors to benefit from phase tracking between the two S-PSS or S-SSS symbols. The S-PSS and S-SSS in combination can convey a sidelink synchronization signal identifier (SLSSID). The S-PSS and S-SSS can also allow a receiving UE to detect a slot boundary of the slot 401 carrying the S-SSB 400. The PSBCH in the S-SSB 400 can transmit a sidelink broadcast channel (SL-BCH) transport block carrying a sidelink master information block (MIB).

In other examples, S-SSBs may have a different structure from the FIG. 4 example. For example, depending on a normal cyclic prefix (CP) or an extended CP employed by a UE transmitting a S-SSB, the number of PSBCH symbols within a slot carrying the S-SSB can be different. In addition, symbols of S-PSS, S-SSS, and PSBCH may be arranged in different orders in other examples.

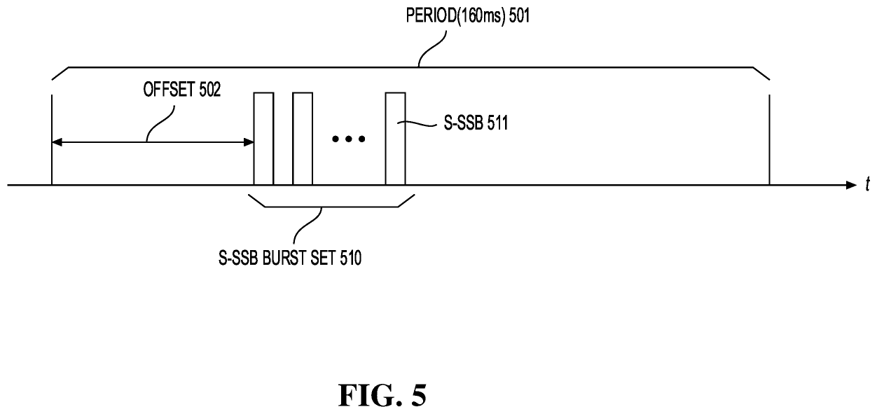

FIG. 5 shows an example of S-SSB transmission according to an embodiment of the disclosure. As shown, a S-SSB burst set 510 can be transmitted periodically, for example, with a period 501 of 160 ms. The S-SSB burst set 510 can include one or more S-SSBs 511. The S-SSBs 511 can be transmitted towards a same direction or multiple directions, for example, with a beam sweeping. In various examples, the maximum number of S-SSBs contained within one S-SSB burst set 510 may vary depending on subcarrier spacings employed by a UE transmitting the S-SSB burst set 510.

In addition, different sets of time domain resources can be configured for a UE for S-SSB transmissions. For example, a UE may perform sidelink communications over multiple carriers which use different synchronization sources. Depending on the used synchronization sources (e.g., a GNSS, a eNB, or a gNB), the UE may transmit S-SSBs with different sets of time domain resources over different carriers. A time domain resource indicator can thus be assigned to each set of time domain resources. The time domain resource indicator can be carried in S-SSBs that are transmitted with the resources indicated by this time domain resource indicator. The time domain resource indicator together with other timing information carried in a S-SSB can be used to derive a frame timing at a receiving UE.

A set of time domain resources can be characterized by an offset 502 and a distribution structure of the S-SSBs 511 within the S-SSB burst set 510. For example, the offset 502 can indicate a time interval between the start of the SSB transmission period 501 and the start of the S-SSB burst set 510. The distribution structure can describe time domain positions of the S-SSBs 511 within the S-SSB burst set 510.

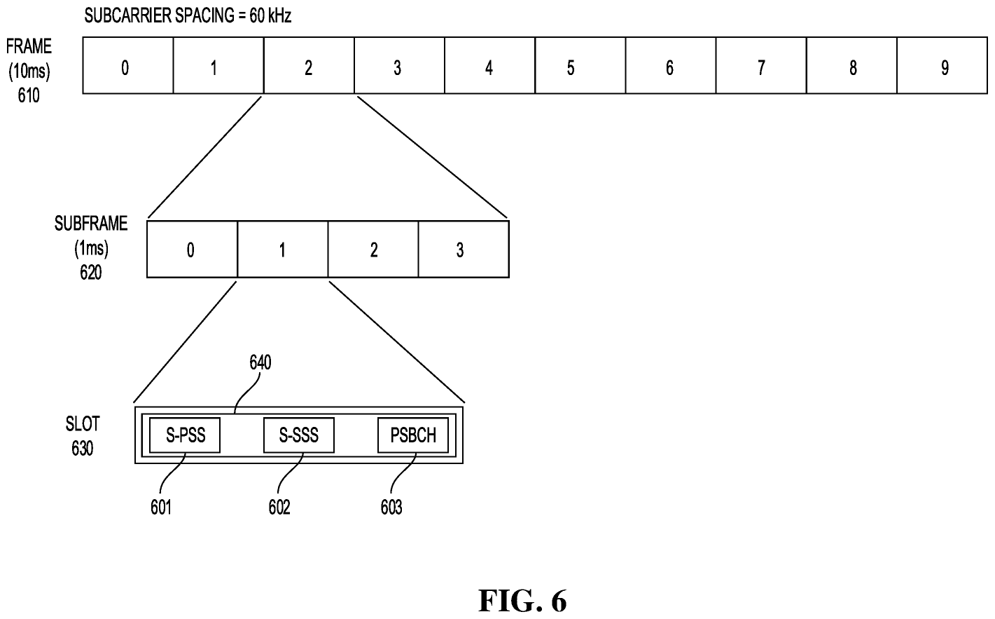

FIG. 6 shows a S-SSB 640 transmitted from a transmitting UE over a slot 630 contained in a subframe 620 of a frame 610. The frame 610 may last 10 ms, and have a subcarrier spacing of 60 kHz. Ten subframes indexed from 0 to 9 are included in the frame 610. The subframe 620 has an index of 2. The subframe 620 includes 4 slots indexed from 0 to 3. A subframe index can also be referred to as a subframe number, while a slot index can be referred to as a slot number. The slot number is not limited to the slot number within a subframe/frame. The slot 630 is the second slot of the subframe 620. The S-SSB 640 can have a structure similar to that of the FIG. 4 example. The S-SSB 640 includes a S-PSS 601, a S-SSS 602, and a PSBCH 603.

In an embodiment, in order to convey a frame timing (e.g., timings and/or frame numbers of frames), the PSBCH 603 can include slot information in addition to a direct frame number (DFN) (e.g., indices of frames from 0 to 1024) and a subframe number. The slot information can be a slot number (or slot index) corresponding to the slot 630 carrying the S-SSB 640. The subframe number (or subframe index) can correspond to the subframe 620 containing the slot 630 carrying the S-SSB 640, while the frame number can correspond to the frame 610 containing the slot 630 carrying the S-SSB 640.

Based on the above slot number of the slot 630, subframe number of the subframe 620, and frame number of the frame 610, a UE receiving the S-SSB 640 can determine a frame timing of the transmitting UE. For example, by detecting the S-PSS 601 and the S-SSS 602, the slot boundary of the slot can be determined. Based on the slot number of the slot 630, a boundary of the subframe 620 can be determined. Accordingly, based on the subframe number of the subframe 620, a boundary of the frame 610 can be determined. As a result, the frame timing (including respective DFNs) of the transmitting UE can be determined.

In the FIG. 6 example, the subcarrier spacing of 60 kHz is used as an example. However, in other examples, different subcarrier spacings may be used for transmitting S-SSBs. Corresponding to different subcarrier spacings, different number of slots can be included in a subframe. Accordingly, depending on the used subcarrier spacings and (pre-)configured time domain resources for S-SSB transmission, the slot number carried in a S-SSB can accordingly be determined.

In a first example, the transmitting UE in the FIG. 6 example uses a gNB or eNB as a synchronization source to obtain a transmission timing, and accordingly determine timing information of slot number, subframe number, and frame number for S-SSB transmission according to NR or LTE synchronization signals (and a MIB) of the gNB or eNB.

In a second example, the transmitting UE in the FIG. 6 example uses a GNSS as a synchronization source to obtain a transmission timing. Accordingly, a slot number can be determined based on a GNSS timing and a subcarrier spacing. More specifically, the slot number can be determined based on a function of μ,Tcurrent, Tref and offsetDFN. According to one example, timing information carried in a PSBCH in a S-SSB can be derived as follows:

DFN=Floor (0.1*0.001*(Tcurrent−Tref−offsetDFN))mod 1024,

subframe number=Floor (0.001*(Tcurrent−Tref−offsetDFN))mod 10,

slot number=Floor (0.001*(Tcurrent−Tref−offsetDFN)*2\hat{ }μ)mod 2\hat{ }μ.

In the above expressions, μ is an integer (e.g., 0, 1, 2, 3, 4, and 5) representing a numerology corresponding to a subcarrier spacing (e.g., 15, 30, 60, 120, 240 kHz). Tcurrent denotes a current time (e.g., a coordinated universal time (UTC) time) obtained from the GNSS in μs. Tref denotes a reference time in μs, such as the reference UTC time 00:00:00 on Gregorian calendar date Jan. 1, 1900 (midnight between Thursday, Dec. 31, 1899 and Friday, Jan. 1, 1900). OffsetDFN denotes a timing difference between a wireless network and the GNSS. For example, the transmitting UE may receive a configuration of the OffsetDFN from the wireless network. Or, the OffsetDFN may be preconfigured to the receiving UE (e.g., stored in the receiving UE or a SIM at the receiving UE). In an example, when OffsetDFN is not configured, a zero value is used in place.

In an embodiment, different from the FIG. 6 example, an alternative method for conveying timing information via a S-SSB is employed. For example, a time domain resource indicator (or time resource indicator) can be carried in the S-SSB. The time domain resource indicator, together with other timing information (e.g., a S-SSB index associated with a S-SSB in a S-SSB burst set) carried in a PSBCH in the S-SSB, can be used to determine a frame timing and/or a subframe timing and/or a slot timing.

For example, considering the FIG. 5 example, a UE receiving the S-SSB carrying the time domain resource indicator can determine a S-SSB distribution structure of the S-SSB burst set 510. The receiving UE can also determine the offset 502. In addition, by decoding the PSBCH in the S-SSB, the S-SSB index of the respective S-SSB within the S-SSB burst set 510 can be determined. Based on the S-SSB index, a position of the respective S-SSB within the S-SSB burst set 510 can be determined. Thereafter, the start timing of the 160 ms S-SSB period 501 can be determined with respect to the respective S-SSB.

In the embodiment of the alternative method for conveying timing information, a PBCH DMRS sequence are used to carry information of the time domain resource indicator in a S-SSB. For example, an identifier (denoted by TimeResourceID) can be used to represent a time domain resource indicator. The TimeResourceID can be used as an initialization value for generating the PBCH DMRS sequence carried in the respective S-SSB. At a receiving UE, by detecting the PBCH DMRS sequence, the respective time domain resource indicator can be determined.

As an example, a PBCH DMRS sequence r(m) is defined by

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) )$$

where c(n) is given by clause 5.2.1 in 3GPP TS 38.211. A scrambling sequence generator can be initialized at the start of respective PSBCH occasion with an initialization value cᵢₙᵢₜ based on a function of the time resource indicator ID (and, optionally, an in-coverage indicator and a SLSSID). As an example, the initialization value can be expressed as follows:

cᵢₙᵢₜ=(Time Re sourceId+1)*2²²+(InCoverageIndicator+1)*2¹⁸+(SLID+1)

where InCoverageIndicator can be a one-bit value indicating whether a UE transmitting the respective PSBCH is under coverage of a eNB/gNB/GNNS, and SLID represents a SLSSID.

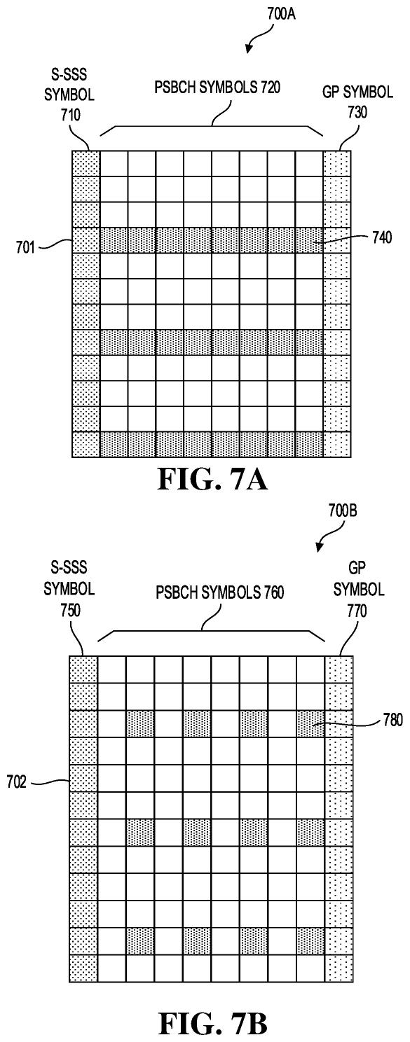

FIGS. 7A and 7B show two PSBCH DMRS mapping patterns 700A and 700B, respectively, according to some embodiments of the disclosure. In FIG. 7A, a first partial S-SSB 701 is shown over an orthogonal frequency-division multiplexing (OFDM) resource grid that includes 12 subcarriers in frequency domain and 10 OFDM symbols in time domain. The 10 OFDM symbols include 8 PSBCH symbols 720 positioned between a S-SSS symbol 710 and a GP symbol 730. Resource elements (REs) 740 carrying PSBCH DMRS sequences are distributed among REs containing PSBCH data over the PSBCH symbols 720.

For example, the PSBCH DMRS REs 740 can have a density of 3 REs per PRB per symbol. Every PSBCH symbol 720 contain the PSBCH DMRS REs.

In FIG. 7B, a second partial S-SSB 702 similarly includes 12 subcarriers in frequency domain and 10 OFDM symbols in time domain. The 10 OFDM symbols include 8 PSBCH symbols 760 positioned between a S-SSS symbol 750 and a GP symbol 770. REs 780 carrying PSBCH DMRS sequences are distributed among REs containing PSBCH data crossing the PSBCH symbols 760. However, the distribution of the PSBCH DMRS REs 780 of the PSBCH DMRS mapping pattern 700B is sparser than that of the PSBCH DMRS mapping patterns 700A. For example, not every PSBCH symbol contains PSBCH DMRS REs 780 in time domain although the PSBCH DMRS REs 780 within the respective PSBCH symbol 760 has a density of 3 REs/PRB in frequency domain. In addition, the frequency location of the PSBCH DMRS REs 780 is shifted one subcarrier upwards compared with that of the PSBCH DMRS REs 740.

In some embodiments, PSBCH DMRS REs of S-SSBs corresponding to different sidelinks are configured to be cyclic-shifted in frequency domain according to SLSSIDs associated with the different sidelinks. In addition, power boosting is used over the PSBCH DMRS REs against interference of co-located PSBCH data REs in neighboring sidelinks to obtain a better channel estimation performance.

In contrast, in some other embodiments, PSBCH DMRS RE mappings for different sidelinks can have a fixed location in frequency domain without frequency cyclic shift based on a function of SLSSIDs. In addition, corresponding to the fixed PABCH DMRS frequency location, no power boosting for PSBCH DMRS REs is employed. For example, S-PSS, S-SSS, and PSBCH symbols within a S-SSB can have the same total power, and the transmission power per RE for PSBCH DMRS can be the same as that of the S-PSS, S-PSS, and the respective PSBCH data.

Automatic gain control (AGC) tuning performance for receiving S-SSBs can be improved when the power boosting for PSBCH DMRS REs is not employed, which is preferred in some embodiments. When the power boosting is not used, frequency cyclic shift of PSBCH DMRS REs becomes unnecessary. Because orthogonality exists among PSBCH DMRSs, collisions between PSBCH DMRSs are preferred than that between co-located PSBCH DMRS and PSBCH data.

In some embodiment, PSBCH DMRS RE density in time domain (in terms of number of PSBCH symbols in a S-SSB that contain PSBCH DMRS) may vary depending on subcarrier spacings used for respective S-SSB transmissions. For example, a 30 or 60 kHz subcarrier spacing can correspond to a smaller time domain PSBCH DMRS RE density that a 15 kHz subcarrier spacing. As symbol duration becomes shorter when subcarrier spacing increases, usage of a smaller time domain PSBCH DMRS RE density can maintain a similar channel estimation performance. Similarly, in some embodiments, less DMRS RE density can also be employed for data transmission over a sidelink. For example, DMRS density for transmission of physical sidelink shared channel (PSSCH) can be decreased when a larger subcarrier spacing is used for sidelink communications. In this way, saved REs can be used for carrying PSSCH data. Spectrum efficiency can thus be improved.

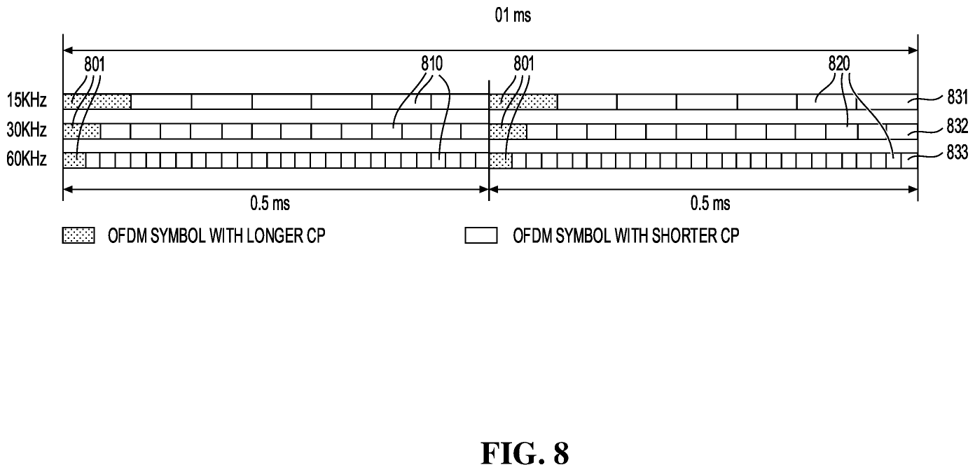

FIG. 8 shows three subframes 831-833 with subcarrier spacings of 15 kHz, 30 kHz, and 60 kHz, respectively. Each subframe 831-833 lasts for 1 ms. Each subframe 831-832 includes a first 0.5 ms half-subframe 810 and a second 0.5 ms half-subframe 820. The subframe 831-833 each includes 14, 28, and 56 symbols, respectively, that are equally distributed among the two half-subframes 810 and 820 in the respective subframe 801-803.

In an embodiment, normal CPs are employed in the subframes 831-833. Accordingly, each symbol in the subframes 831-833 has a normal CP. Particularly, within each 0.5 ms half-subframe 810 or 820, the first symbol 801 has a normal CP longer than the other symbols. Accordingly, in the embodiment, in order to facilitate AGC tuning over the first symbol of a S-SSB, S-SSBs can be transmitted at the beginning of each 0.5 ms half-subframe. For example, each S-SSB in a S-SSB burst set can be arranged to be adjacent to a starting boundary of a 0.5 ms half-subframe. Under such an arrangement, the first symbol of each S-SSB will have a longer normal CP prepended. As a result, a longer duration of the first symbol in the respective S-SSB can be available for AGC tuning. Thus, a performance of S-SSB reception can be improved.

It is noted that the starting symbols 801 of 0.5 ms half-subframes are candidate symbols. Depending on a structure of a S-SSB burst set, a starting symbol of a 0.5 ms half-subframe may or may not be occupied by a S-SSB.

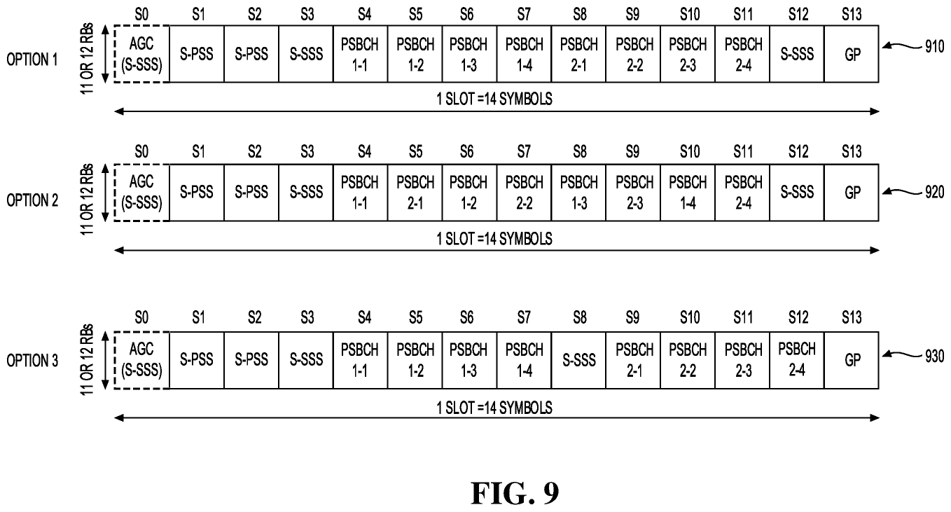

FIG. 9 shows three example S-SSBs 910-930 according to some embodiments of the disclosure. The S-SSBs 910-930 each occupy 11 or 12 RBs in frequency domain and 13 symbols in time domain, and are appended with a GP symbol. The S-SSBs 910-930 each include 1 AGC symbol (e.g., based on S-SSS), 2 S-PSS symbols, 2 P-SSS symbols, 8 PSBCH symbols. The S-SSBs 910-930 each include a first and a second PSBCHs. The first PSBCH includes 4 symbols labelled with 1-1, 1-2, 1-3, and 1-4, while the second PSBCH includes 4 symbols labelled with 2-1, 2-2, 2-3, and 2-4. Those symbols of the S-SSBs 910-930 are arranged as shown in FIG. 9.

As shown, PSBCH repetition is employed with three possible options: Option 1, Option 2, and Option 3 corresponding to the three S-SSBs 910-930. In Option 1 and Option 3 (channel by channel repetition), the PSBCH is repeatedly transmitted in a way that the symbols of the first PSBCH are first transmitted, and followed by the symbols of the second PSBCH. In Option 2 (symbol by symbol repetition), each PSBCH symbol is repeated and transmitted successively. Options 1 and 3 can facilitate early termination of decoding the PSBCH at a receiver in case of a good channel condition (e.g., a high signal to interference plus noise ratio (SINR)). Option 2 can improve channel estimation and enables energy combination between two consecutive PSBCH symbols for decoding the respective PSBCH.

In the FIG. 9 example, the S-PSS and S-SSS can be generated with length-127 m-sequence located in the center 127 subcarriers of the 11 or 12 RBs (1 RB=12 subcarriers). the S-PSS and S-SSS in combination can carry a SLSSID which can be used to identify a synchronization source type and priority. For example, two first UEs synchronized to a eNB and a gNB, respectively, can be assigned with different sets of sequences for S-PSS/S-SSS generation corresponding to different SLSSIDs. Upon the detection of a SLSSID of one of the two directly synchronized first UE, a second UE (a.k.a indirectly synchronized second UE) can know the synchronization source of the first UE (whether it is the eNB or the gNB) for proper synchronization prioritization if needed. The unused resource in the frequency domain in S-PSS/S-SSS symbols can be set to zero power.

In the FIG. 9 example, the PSBCH symbols can be transmitted over 11 or 12 RBs depending on the subcarrier spacing. For example, in one embodiment, for 15 kHz and 30 kHz subcarrier spacings, 12 RBs can be used, while for 60 kHz, 11 RBs can be used. The purpose is to fit the whole S-SSB within 10 MHz bandwidth (only 11 RBs are supported for 60 kHz subcarrier spacing within 10 MHz bandwidth). The total number of REs for PSBCH data can be the same regardless of the subcarrier spacing, which can ensure the same decoding process for PSBCH data. Moreover, to reuse a NR PBCH receiver for complexity and cost reduction, the total (48×9/12×12) REs (same as NR PBCH data RE number) can be used to carry PSBCH data in FIG. 9 by sharing the same polar coding and interleaver pattern as a NR interface.

In addition, 15 kHz and 30 kHz subcarrier spacings can also have the same PSBCH DMRS pattern, i.e., comb-3 pattern (1 DMRS RE every 4 REs, or 3 DMRS per 12 subcarriers) in each symbol with total 12 RBs. For 60 kHz subcarrier spacing, due to the shorter symbol length with the less impact from Doppler effect, sparser PSBCH DMRS can be used to achieve the same performance with less DMRS REs to fit 11 RBs for S-SSB in total. In this case, the total 8 RBs per PBCH channel over 4 symbols (less than 12 RBs for 15/30 kHz subcarrier spacing) can be used for carrying PSBCH DMRS.

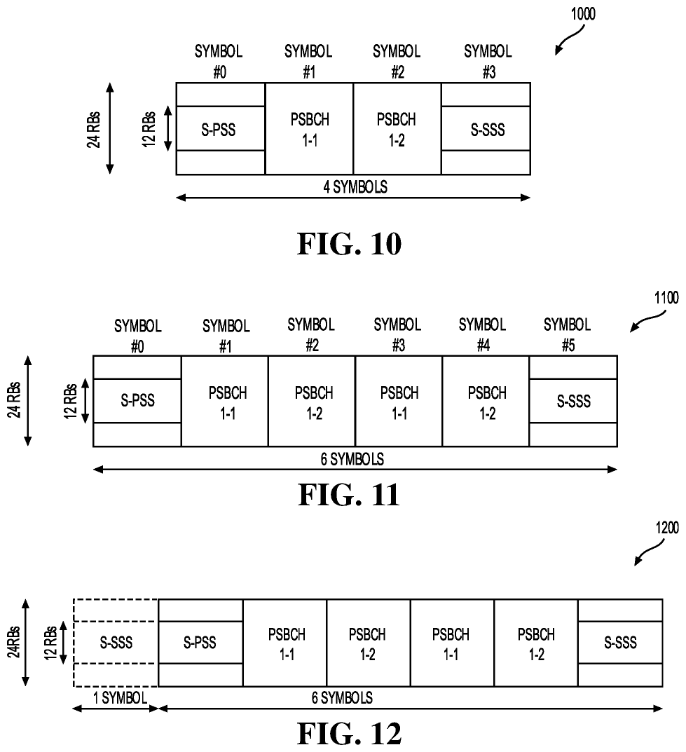

FIG. 10 shows an example S-SSB 1000 according to an embodiment. The S-SSB 1000 occupies 24 RBs in frequency domain and 4 symbols in time domain. The S-SSB 1000 includes 1 S-PSS symbol, 2 PSBCH symbols, and 1 S-SSS symbol in sequence. The S-PSS and S-SSS can be generated with length-127 m-sequence located in the central 127 subcarriers of the 24 resource blocks. The PSBCH symbols can be transmitted over 24 RBs including PSBCH-DMRS. The frequency domain precoder cycling can be supported, for example, with 6 RBs per precoding group (PRG) and up to 4 PRGs for exploring the frequency diversity gain. Alternatively, the time domain precoder cycling can be supported independently or jointly with frequency domain precoder cycling. 1 port pre-coder cycling and/or space-frequency block coding (SFBC) transmission can be supported for PSBCH transmission.

FIG. 11 shows another example S-SSB 1100 with PSBCH repetition. The difference between the FIG. 10 and FIG. 11 example is the repetition of PSBCH symbols. For example, a PSBCH channel with two (or more) PSBCH symbols in FIG. 10 can be repeated once (or multiple times) with a total of four (or more) symbols for PSBCH transmission. Accordingly, a receiving UE can decode these two (or more) PSBCH channels independently or with soft combine for improving decoding performance and transmission coverage. In addition, channel estimation for PSBCH can be performed jointly across 4 PSBCH symbols resulting in a better performance. Alternatively, the PSBCH symbols can also be repeated symbol by symbol for one or multiple times, e.g., PBCH 1-1, PBCH 1-1, PBCH 1-2 and PBCH 1-2 for one repetition on each symbol.

FIG. 12 shows an example S-SSB 1200 with additional symbol(s) for AGC tuning. Considering channel variation and interference or loading dramatic change, AGC may have to be returned for S-SSB reception each time, especially when the time interval between two consecutive S-SSBs are too large to have any correlation. In this case, one (or multiple) AGC symbol may be added in the front of the S-SSB 1200 for the proper reception of S-PSS.

As shown in FIG. 12, one (or more) S-SSS symbol added in the front of S-SSB 1200 is used for AGC tuning before S-PSS reception. Such S-SSS symbol can be a repetition of the S-SSS symbol in S-SSB (the last symbol of the S-SSB). Alternatively, such S-SSS symbol for AGC tuning can be complementary to the S-SSS in S-SSB with a S-SSS sequence number different from the S-SSS sequence in S-SSS of S-SSB. In addition, S-SSS for AGC tuning can also help to improve S-SSS detection performance. On the other hand, such S-SSS for AGC tuning can be also considered as a part of S-SSB.

The number of S-SSS for AGC tuning can be pre-defined or (pre-)configured. The number of S-SSS for AGC tuning can be dependent on the S-SSB numerology and/or S-SSB periodicity, e.g., more symbols are used with the larger subcarrier spacing and/or larger S-SSB periodicity whereas less (or zero) symbols are used for smaller subcarrier and/or smaller S-SSB periodicity. For example, for 30 kHz S-SSB, 1 symbol of S-SSS is (pre)configured or defined for AGC tuning whereas 2 symbols of S-SSS may be used with 60 kHz S-SSB.

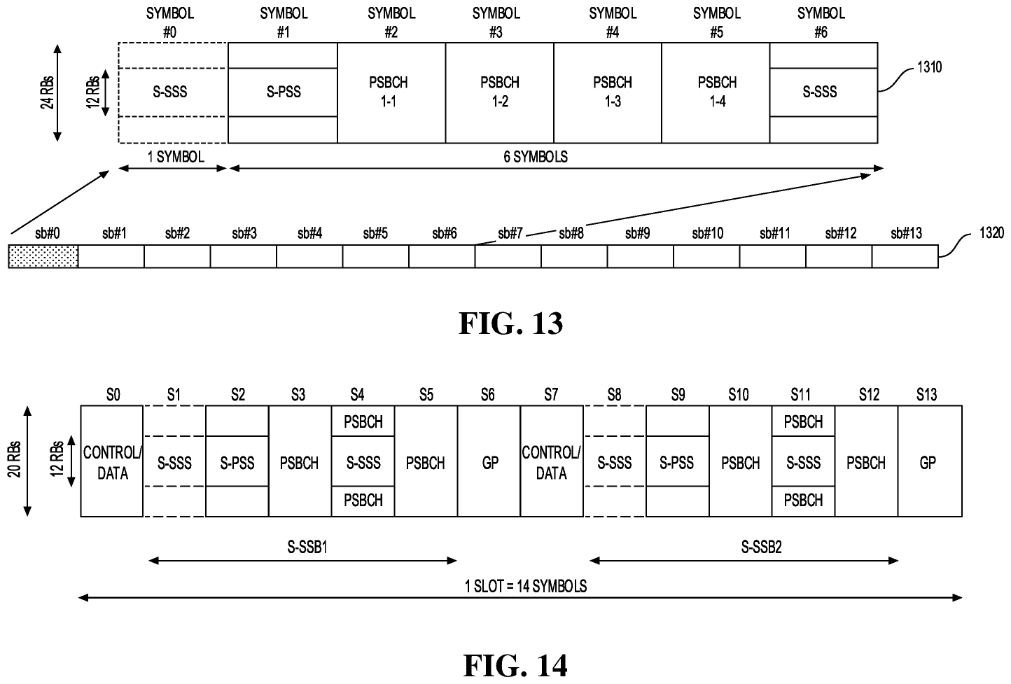

FIG. 13 shows an example of mapping a AGC tuning symbol associated with a S-SSB 1310 to a first symbol of a slot 1320 with a longer CP. The symbol(s) for AGC tuning followed by S-SSB can be placed in the first symbol of a 0.5 ms half-subframe to gain more time for AGC tuning. In this case, the S-SSB location will be adjacent to the boundary of the 0.5 ms half-subframe. In other examples, a S-SSB location can be any location within a slot.

FIG. 14 shows an example of S-SSBs with GP symbols for beam-switching. The GP symbols can be placed before and/or after each S-SSB (including AGC symbol). Especially in case of a S-SSB burst set with multiple-beam transmissions, at least one GP symbol is needed between two consecutive S-SSBs within the S-SSB burst set for potential analog beam switching by a transmitting UE. In case of transmission of a S-SSB burst set including multiple S-SSBs, it can be (pre)configured and/or defined that the multiple S-SSBs are transmitted with the same analog beams or not. A S-SSB index number can be the same if the analog beams are same. The S-SSB index can be carried in PBCH DMRS during sequence generation with an initialization value corresponding to the respective S-SSB index.

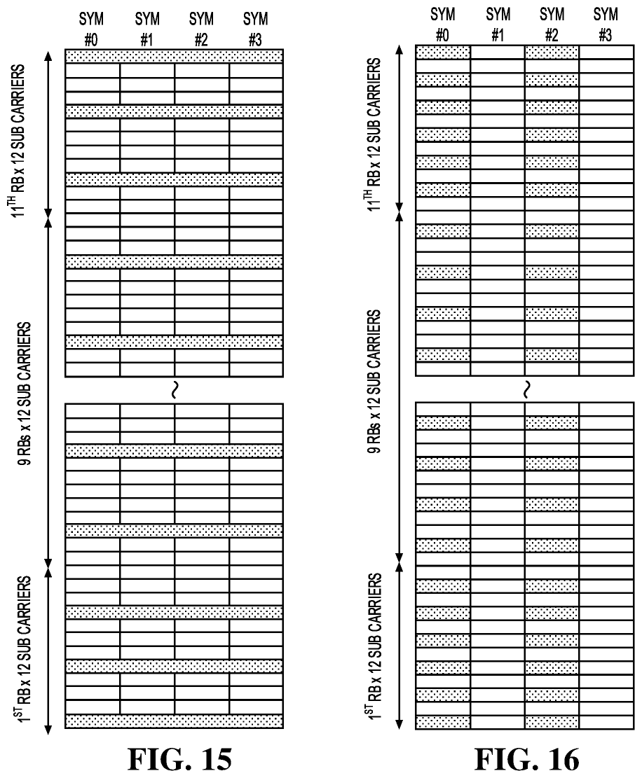

FIG. 15 shows a PSBCH DMRS pattern with a 60 kHz subcarrier spacing. The pattern in FIG. 15 can be include three parts: the first and the last RBs are constructed with a special pattern based on comb-3 pattern (evenly or non-evenly distribution for DMRS). For the remaining central 9 RBs in frequency domain, a comb-2 pattern is used. In time domain, the same PSBCH DMRS patterns can be used in each symbol of the PSBCH channel.

FIG. 16 shows another PSBCH DMRS pattern with a 60 kHz subcarrier spacing. The pattern in FIG. 16 can include three parts: the first and the last RBs are constructed with a special pattern based on comb-6 pattern (evenly or non-evenly distribution). For the remaining central 9 RBs in frequency domain, a comb-4 pattern is used. In time domain, the same PSBCH DMRS patterns are applied for one of every two symbols of the PSBCH channel. The denser PSBCH DMRS for the first and last RBs of a PSBCH can help to improve the edge PRB channel estimation.

The PSBCH DMRS pattern location can be fixed in time and/or frequency domain without any cyclic shift to ensure the better channel estimation or cancellation in case of collision with other PSBCHs from other UEs. Which PSBCH DMRS pattern or S-SSB structure is used can be indicated by a network configuration or a pre-configuration at the transmitting UE. The configuration or pre-configuration can be subcarrier spacing dependent. The subcarrier spacing can be further dependent on the band and/or (the minimum) bandwidth of the transmitting UE.

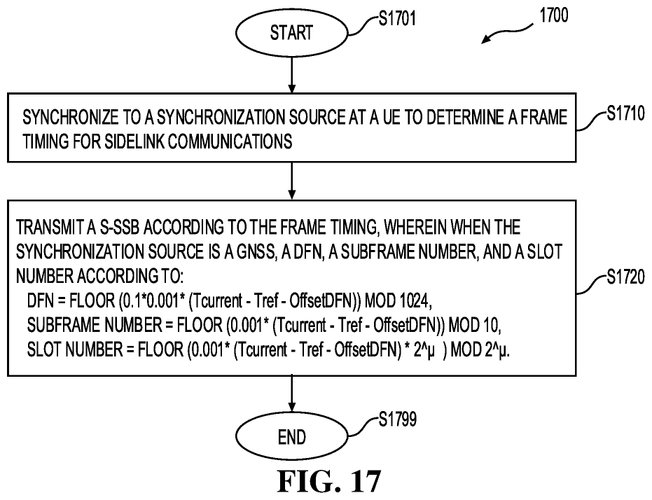

FIG. 17 shows a synchronization process 1700 of sidelink communications according to an embodiment of the disclosure. The process 1700 can be performed at a UE capable of sidelink communications. The process 1700 can start from S1701, and proceed to S1710.

At S1710, synchronization to a synchronization source is performed at the UE to determine a frame timing for sidelink communications. For example, based on a (pre-)configured synchronization priority rule, the UE can select a synchronization source with the highest priority from multiple candidate synchronization sources, and determine a transmission timing for sidelink communications based on a synchronization signal transmitted from the synchronization source.

At S1720, a S-SSB is transmitted from the UE according to the determined frame timing. The S-SSB can be used as a synchronization source for other UEs to perform sidelink synchronizations.

At S1710, when the synchronization source is a GNSS, a slot number can be determined based on a GNSS timing and a subcarrier spacing. In one example, the slot number can be determined according to the following expression:

slot number=Floor (0.001*(Tcurrent−Tref−offsetDFN)*2\hat{ }μ)mod 2\hat{ }μ,

where μ is an integer indicating a numerology corresponding to a subcarrier spacing, Tcurrent denotes a current time obtained from the GNSS in μs, Tref denotes a reference time in μs, and offsetDFN denotes a timing difference between a wireless network and the GNSS.

In other embodiments, a direct frame number (DFN) and/or a subframe number may be determined by the following expressions:

DFN=Floor (0.1*0.001*(Tcurrent−Tref−offsetDFN))mod 1024,

subframe number=Floor (0.001*(Tcurrent−Tref−offsetDFN))mod 10.

The process 1700 can proceed to S1799 and terminate at S1799.

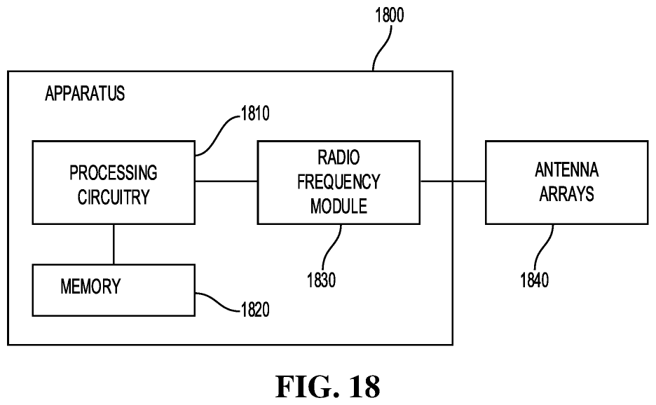

FIG. 18 shows an exemplary apparatus 1800 according to embodiments of the disclosure. The apparatus 1800 can be configured to perform various functions in accordance with one or more embodiments or examples described herein. Thus, the apparatus 1800 can provide means for implementation of mechanisms, techniques, processes, functions, components, systems described herein. For example, the apparatus 1800 can be used to implement functions of UEs or BSs in various embodiments and examples described herein. The apparatus 1800 can include a general purpose processor or specially designed circuits to implement various functions, components, or processes described herein in various embodiments. The apparatus 1800 can include processing circuitry 1810, a memory 1820, and a radio frequency (RF) module 1830.

In various examples, the processing circuitry 1810 can include circuitry configured to perform the functions and processes described herein in combination with software or without software. In various examples, the processing circuitry 1810 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 1810 can be a central processing unit (CPU) configured to execute program instructions to perform various functions and processes described herein. Accordingly, the memory 1820 can be configured to store program instructions. The processing circuitry 1810, when executing the program instructions, can perform the functions and processes. The memory 1820 can further store other programs or data, such as operating systems, application programs, and the like. The memory 1820 can include non-transitory storage media, such as a read only memory (ROM), a random access memory (RAM), a flash memory, a solid state memory, a hard disk drive, an optical disk drive, and the like.

In an embodiment, the RF module 1830 receives a processed data signal from the processing circuitry 1810 and converts the data signal to beamforming wireless signals that are then transmitted via antenna arrays 1840, or vice versa. The RF module 1830 can include a digital to analog convertor (DAC), an analog to digital converter (ADC), a frequency up convertor, a frequency down converter, filters and amplifiers for reception and transmission operations. The RF module 1830 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 1840 can include one or more antenna arrays.

The apparatus 1800 can optionally include other components, such as input and output devices, additional or signal processing circuitry, and the like. Accordingly, the apparatus 1800 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

1. A method, comprising:
synchronizing to a synchronization source at a user equipment (UE) to determine a frame timing for sidelink communications; and
transmitting a sidelink synchronization signal block (S-SSB) according to the frame timing,
wherein when the synchronization source is a global navigation satellite system (GNSS), the determining the frame timing includes determining a slot number based on a GNSS timing and a subcarrier spacing.

2. The method of claim 1, wherein the S-SSB includes a physical sidelink broadcast channel (PSBCH) that carries information of the slot number.

3. The method of claim 1, wherein the S-SSB includes a PSBCH demodulation reference signal (DMRS) sequence that is generated with a time domain S-SSB transmission resource indicator as an initialization value.

4. The method of claim 1, wherein the S-SSB has a PSBCH DMRS resource element (RE) mapping of a fixed RE location with respect to different sidelink synchronization signal (SLSS) identifier (ID).

5. The method of claim 1, wherein the S-SSB includes sidelink primary synchronization signal (S-PSS) symbols of a S-PSS, sidelink secondary synchronization signal (S-SSS) symbols of a S-SSS, and PSBCH symbols of a PSBCH,
each of the S-PSS symbols, the S-SSS symbols, and the PSBCH symbols has a same total transmission power, and
a transmission power per RE of a PSBCH DMRS in the S-SSB is the same as that of the S-PSS, the S-SSS, or the PSBCH in the S-SSB.

6. The method of claim 1, further comprising:
transmitting a sequence of S-SSBs that are evenly distributed in time domain in a S-SSB burst set.

7. The method of claim 6, wherein the sequence of S-SSBs are each positioned at the beginning of a 0.5 ms half-subframe.

8. The method of claim 1, wherein determining the slot number based on the GNSS timing and the subcarrier spacing further comprising:
determining the slot number based on a function of μ,Tcurrent, Tref and offsetDFN,
where μ is an integer indicating a numerology corresponding to a subcarrier spacing, Tcurrent denotes a current time obtained from the GNSS in μs, Tref denotes a reference time in μs, and offsetDFN denotes a timing difference between a wireless network and the GNSS.

9. The method of claim 8, wherein the slot number is determined according to:
slot number=Floor (0.001*(Tcurrent−Tref−offsetDFN)*2\hat{ }μ)mod 2\hat{ }μ.

10. An apparatus, comprising circuitry configured to:
synchronize to a synchronization source at a user equipment (UE) to determine a frame timing for sidelink communications; and
transmit a sidelink synchronization signal block (S-SSB) according to the frame timing,
wherein when the synchronization source is a global navigation satellite system (GNSS), the circuitry is configured to:
determine a slot number based on a GNSS timing and a subcarrier spacing.

11. The apparatus of claim 10, wherein the S-SSB includes a physical sidelink broadcast channel (PSBCH) that carries information of the slot number.

12. The apparatus of claim 10, wherein the S-SSB includes a PSBCH demodulation reference signal (DMRS) sequence that is generated with a time domain S-SSB transmission resource indicator as an initialization value.

13. The apparatus of claim 10, wherein the S-SSB has a PSBCH DMRS resource element (RE) mapping of a fixed RE location with respect to different sidelink synchronization signal (SLSS) identifier (ID).

14. The apparatus of claim 10, wherein the S-SSB includes sidelink primary synchronization signal (S-PSS) symbols of a S-PSS, sidelink secondary synchronization signal (S-SSS) symbols of a S-SSS, and PSBCH symbols of a PSBCH,
each of the S-PSS symbols, the S-SSS symbols, and the PSBCH symbols has a same total transmission power, and
a transmission power per RE of a PSBCH DMRS in the S-SSB is the same as that of the S-PSS, the S-SSS, or the PSBCH in the S-SSB.

15. The apparatus of claim 10, wherein the circuitry is further configured to:
transmit a sequence of S-SSBs that are evenly distributed in time domain in a S-SSB burst set.

16. The apparatus of claim 15, wherein the sequence of S-SSBs are each positioned at the beginning of a 0.5 ms half-subframe.

17. The apparatus of claim 10, wherein the circuitry is further configured to:
determine the slot number based on a function of μ,Tcurrent, Tref and offsetDFN,
where μ is an integer indicating a numerology corresponding to a subcarrier spacing, Tcurrent denotes a current time obtained from the GNSS in μs, Tref denotes a reference time in μs, and offsetDFN denotes a timing difference between a wireless network and the GNSS.

18. The apparatus of claim 17, wherein the slot number is determined according to:
slot number=Floor (0.001*(Tcurrent−Tref−offsetDFN)*2\hat{ }μ)mod 2\hat{ }μ.

19. A non-transitory computer-readable medium storing instructions that, when executed by a processor, cause the processor to perform a method, the method compring:
synchronizing to a synchronization source at a user equipment (UE) to determine a frame timing for sidelink communications; and
transmitting a sidelink synchronization signal block (S-SSB) according to the frame timing,
wherein when the synchronization source is a global navigation satellite system (GNSS), the determining the frame timing includes determining a slot number based on a GNSS timing and a subcarrier spacing.

20. The non-transitory computer-readable medium of claim 19, wherein determining the slot number based on the GNSS timing and the subcarrier spacing further comprising:
determining the slot number based on a function of μ,Tcurrent, Tref and offsetDFN,
where μ is an integer indicating a numerology corresponding to a subcarrier spacing, Tcurrent denotes a current time obtained from the GNSS in μs, Tref denotes a reference time in μs, and offsetDFN denotes a timing difference between a wireless network and the GNSS.
